(19) United States
(12) Patent Application Publication
(10) Pub. No.: US 2024/0367256 A1
(43) Pub. Date: Nov. 7, 2024

(54) BEAM CUTTING METHOD, COMPUTER PROGRAM AND BEAM CUTTING APPARATUS

(71) Applicant: TRUMPF Werkzeugmaschinen SE + Co. KG, Ditzingen (DE)

(72) Inventors: Winfried Magg, Ditzingen (DE); Steffen Keßler, Stuttgart (DE); David Schindhelm, Stuttgart (DE); Alexander Schmid, Gärtringen (DE)

(21) Appl. No.: 18/776,298

(22) Filed: Jul. 18, 2024

Related U.S. Application Data
(63) Continuation of application No. PCT/EP2022/084992, filed on Dec. 8, 2022.

(30) Foreign Application Priority Data
Jan. 21, 2022 (DE) 10 2022 101 429.0

(51) Int. Cl. B23K 26/03; B23K 26/38

(52) U.S. Cl. CPC B23K 26/03; B23K 26/38

(57) ABSTRACT

A beam cutting method includes conducting at least one cutting procedure while capturing at least one quality parameter. The at least one cutting procedure is intermittently implemented with an operation not subject to a closed-loop control and intermittently implemented with an operation subject to the closed-loop control. The beam cutting method further includes defining a process window in a parameter space of at least one process parameter, and choosing the at least one process parameter within the process window during the operation not subject to the closed-loop control. The at least one process parameter is allowed to be outside of the process window during the operation subject to the closed-loop control. The beam cutting method further includes adapting the process window based on changes in the at least one process parameter during the operation subject to the closed-loop control and/or changes in the at least one quality parameter.

### CROSS REFERENCE TO RELATED APPLICATIONS

This application is a continuation of International Application No. PCT/EP2022/084992 (WO 2023/138834 A1), filed on Dec. 8, 2022, and claims benefit to German Patent Application No. DE 10 2022 101 429.0, filed on Jan. 21, 2022. The aforementioned applications are hereby incorporated by reference herein.

### FIELD

Embodiments of the present invention relate to a beam cutting method, as well as to a computer program for controlling a beam cutting apparatus and to a beam cutting apparatus.

### BACKGROUND

A beam cutting method of the aforementioned type is known from e.g. DE 10 2019 106 939 A1 or DE 10 2013 218 421 A1.

In particular, DE 10 2019 106 939 A1 describes a piece of machine learning equipment in a piece of processing state adaptation equipment. As state variables, which express a current state in an environment, the piece of machine learning equipment observes laser processing state data within the scope of laser processing and gas target deviation data, which express a target deviation of a pressure loss or a through-flow of an auxiliary gas. Then, the piece of machine learning equipment acquires determination data for determining the quality of a workpiece processed on the basis of the laser processing state and learns the target deviation of the pressure loss or through-flow of the auxiliary gas and the adaptation of the laser processing state within the scope of laser processing in association with one another using the determination data and the observed state variables.

DE 10 2013 218 421 A1 has disclosed a piece of equipment for monitoring, more particularly controlling, a cutting process on a workpiece. The piece of equipment comprises a focusing element for focusing a high-energy beam, in particular a laser beam, on the workpiece, an image capturing device for capturing a region on the workpiece to be monitored, the region comprising an interaction region of the high-energy beam with the workpiece, and an evaluation device designed to ascertain at least one characteristic variable of the cutting process, in particular a kerf formed during the cutting process, on the basis of the captured interaction region. The piece of equipment may additionally comprise an open-loop and/or closed-loop control device for open-loop and/or closed-loop control of parameters of the cutting process on the basis of the at least one characteristic variable ascertained.

DE 10 2019 220 478 A1 has disclosed a method for ascertaining cutting parameters for a laser cutting machine. The method comprises the steps of
A) receiving at least one machine parameter, at least one process parameter and/or at least one material parameter;
B) starting from properties, which can be influenced by the cutting parameters, of a laser-cut edge able to be cut by the laser cutting machine;
C) receiving a weighting of the properties;
D) ascertaining the cutting parameters using the at least one machine parameter, the at least one process parameter and/or the at least one material parameter and also using the weighted properties.

EP 2 163 339 A1 describes a laser cutting apparatus using a laser beam to cut a workpiece along a cutting line with a variable cutting speed. The laser cutting apparatus comprises a movable processing head for placing the laser beam on the respective workpiece, a user interface for specifying the respective cutting line and for specifying a minimum accuracy for the laser beam trajectory, and a controller for controlling the movement of the processing head relative to the respective workpiece along the cutting line and for controlling a plurality of process variables of a cutting process, a cutting trajectory of the laser beam along the cutting line being able to be created during said movement during the cutting process. A first subset of the process variables exclusively comprises one or more process variables that influence the power of the laser beam available for cutting. A second subset of the process variables exclusively comprises one or more process variables that have no influence on the power of the laser beam available for cutting. At least one process variable from the second subset is controllable by means of the controller on the basis of at least one variable control parameter, the respective value of which is determinable by the controller on the basis of at least one of the respective registered values for the speed of the processing head and according to rules implemented within the controller.

During beam cutting procedures, for example within the scope of laser cutting, sufficiently severe and suddenly occurring disturbances may lead to a miscut despite active control of cutting procedure process parameters and may reduce the further cutting capability of a beam cutting apparatus. Even if cutting is conducted without closed-loop control, i.e. with fixedly prescribed process parameters, disturbances can influence the cutting capability. The consequence of both may be that despite active control, a miscut occurs in the event of a renewed start into a controlled cut, and a manual operator intervention is required to reestablish the cutting capability of the beam cutting apparatus.

### SUMMARY

Embodiments of the present invention provide a beam cutting method. The beam cutting method includes conducting at least one cutting procedure while capturing at least one quality parameter. The at least one cutting procedure is intermittently implemented with an operation not subject to a closed-loop control and intermittently implemented with an operation subject to the closed-loop control. The beam cutting method further includes defining a process window in a parameter space of at least one process parameter, and choosing the at least one process parameter within the process window during the operation not subject to the closed-loop control. The at least one process parameter is allowed to be outside of the process window during the operation subject to the closed-loop control. The beam cutting method further includes adapting the process window based on changes in the at least one process parameter during the operation subject to the closed-loop control and/or changes in the at least one quality parameter.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic side view of a beam cutting apparatus according to embodiments of the invention;

FIG. 2 shows a schematic plan view of the beam cutting machine of FIG. 1, according to some embodiments;

FIG. 3 shows a schematic illustration of an originally specified process window and a process window with adapted boundaries in a parameter space of process parameters, according to some embodiments; and

FIG. 4 shows a schematic flowchart of a cutting method according to embodiments of the invention.

### DETAILED DESCRIPTION

Embodiments of the invention can improve reliability within the scope of conducting beam cutting procedures.

Embodiments of the invention provide a beam cutting method. The beam cutting method preferably is a laser cutting method. Alternatively, the method might be a plasma cutting method, a flame cutting method or a waterjet cutting method, for example. A preferably planar or tubular workpiece is severed in the process by virtue of a beam, in particular a laser beam, being directed at the workpiece.

At least one cutting procedure is conducted while capturing at least one quality parameter. In this context, a cutting procedure is especially understood to mean the procedure between the start and end of a separating cut, in the event of which the workpiece is severed in the thickness direction. A plurality of cutting procedures are typically conducted within the scope of the method according to embodiments of the invention. A plurality of cutting procedures can be conducted on the same workpiece or on different workpieces. The at least one quality parameter describes a quality of the separating cut. In particular, the at least one quality parameter might be selected from presence of a separating cut (i.e. whether or not the workpiece is completely severed in the thickness direction), width and/or profile (e.g. periodically oscillating) of a cut gap, inclination of a cutting front and/or shape of a cutting front.

A process window is defined in a parameter space of at least one process parameter, by preference a plurality of process parameters. The process window defines the region in the parameter space in which a successful and high quality, or at least satisfactory, cut is to be expected on the basis of information available in advance. The process window might be a point in the parameter space. In particular, the process window can be predefined as a point in the parameter space. The process window might remain a point or else be augmented to form a confined region during the adaptation. It is understood that in an alternative the process window might also be predefined as a confined region in the parameter space and might remain such a region or shrink to a point during the adaptation. In particular, the process parameters can be selected from feed rate, laser power, focal position, focal diameter, distance of a nozzle from a workpiece, gas pressure of a cutting gas and/or gas composition of a cutting gas.

By preference, the process window is predefined on the basis of machine properties of a beam cutting apparatus on which the method is conducted and/or on the basis of workpiece properties of the workpiece to be cut. This allows consideration to be given to the fact that these properties might influence the process parameter values to be applied for a successful cut. The machine properties might be selected from cutting head type, wavelength and/or maximum power of a laser beam, type and/or composition of a cutting gas, nozzle type, fiber-optic cable type and/or cutting optics type. In an alternative to that or in addition, the machine properties might be selected from
a deviation of the focal position from a target value, caused for example by heating of the optics, by protection glass contamination, etc. (the actual focal position then no longer corresponds to the set focal position; additionally, there might be a change in the beam diameter),
an off-center position of the laser beam relative to the nozzle (this may lead to a directional dependence),
a defect on the nozzle, for example slag adherence (this may interfere with the gas beam and the melt expulsion),
presence of a support bar immediately below the processing zone for the cutting procedure (this may lead to problems, especially due to a worn out bar or slag-coated bar), and/or
purity of the cutting gas or type and/or amount of contamination in the cutting gas.

The workpiece properties might be selected from material of the workpiece, thickness of the workpiece, temperature of the workpiece and/or nature of the surface of the workpiece.

According to embodiments of the invention, the at least one cutting procedure is intermittently implemented with an operation not subject to closed-loop control and intermittently implemented with an operation subject to closed-loop control.

The operation not subject to closed-loop control can also be referred to as operation subject to open-loop control. During operation not subject to closed-loop control, the process parameter or parameters is/are chosen within the process window. Control within the scope of operation not subject to closed-loop control is implemented within the meaning of feedforward control by specifying the process parameter or parameters within the process window without quality parameter feedback. In particular, provision can be made for the process parameters to remain unchanged within a respective phase of operation not subject to closed-loop control.

The process parameters can be outside of the process window during operation subject to closed-loop control. During operation subject to closed-loop control, the process parameter or parameters is/are modified on the basis of the captured quality parameters. This can be implemented within the meaning of feedback control with a closed control loop. For example, the object of closed-loop control might lie in increasing the cut speed (feed rate) without a noticeable change in the cut quality. In particular, the closed-loop control can be set to be as productive as possible, i.e. with the greatest possible feed within the process window. In an alternative, the closed-loop control might for example be set such that it operates as robustly as possible, i.e. a point in the process window is chosen for which disturbances must occur as severely and/or as quickly as possible in order to remove the process from a quality window yielding a successful and high-quality cut (for example closed-loop control tending to lead to a slightly smaller feed).

According to embodiments of the invention, the process window is adapted by virtue of using insight from the previous progress of the at least one cutting procedure. The process parameters are chosen within the adapted process window for a subsequent operation not subject to closed-loop control. The boundaries or edges of the process window might be modified during its adaptation.

In particular, the process window can be adapted on the basis of changes in the process parameters during operation subject to closed-loop control. This allows consideration to be given to the fact that-depending on the circumstances of the specific cutting procedure—it is possible to depart from the previously defined process window without putting the success of the cutting procedure at risk, or that cutting procedure success cannot be guaranteed even within the previously defined process window. The process window is adapted continually by preference.

In an alternative to that or in addition, the boundaries of the process window can be adapted on the basis of changes in the at least one quality parameter. In this respect, the changes in the at least one quality parameter can be captured during operation not subject or subject to closed-loop control. This allows consideration to be given to changes in quality that occur spontaneously or independently of changes in the process parameters, for example spatter on a protective glass or slag adherences to a nozzle, or else to continual changes, for example the optics heating up, and allows for compensation of the effects thereof.

By adapting the process window, experience from previous cutting procedures is incorporated in the definition of the process parameters for a subsequent operation not subject to closed-loop control. The use of the adapted process window thus improves the reliability of the cutting procedure and may increase the cut quality. Disturbances over the course of the cutting procedure, which had to be rectified by a manual operator intervention to date, are compensated for by the adaptive adaptation of the process window within the scope of the method according to embodiments of the invention. In other words, the experiences from previous cutting procedures are involved in defining the current process window, i.e. the current process window is a function of the available information (for example of all time profiles, all relevant and available variables such as e.g. process parameters, sensor system quality parameters, parameters such as cutting direction, cutting location, etc.). Depending on the mode of operation, the cutting procedure is continued within the current process window during operation both subject to closed-loop control and not subject to closed-loop control; suitable rules may be defined in this respect.

It is preferable for the process window to be adapted continually or iteratively. As a result, said process window always corresponds to the current conditions. Hence, a high process stability can be achieved. For example, there can be a respective incremental adaptation in the case of a plurality of incomplete cutting actions.

By preference, the changes in the process parameters during operation subject to closed-loop control and/or the changes in the at least one quality parameter are captured in spatially dependent and/or directionally dependent fashion. The process window can be adapted accordingly in spatially dependent and/or directionally dependent fashion. As a result, anisotropies or inhomogeneities of a cutting apparatus in its work space can be taken into account and compensated for. In an alternative to that or in addition, the changes in the process parameters during operation subject to closed-loop control and/or the changes in the at least one quality parameter can be captured in temporally dependent fashion, and the process window can be adapted in temporally dependent fashion.

The adaptation of the process window can also give consideration to the amount of time for which the information about cutting location or cutting direction is available or how old this information is. The machine is more likely to still be in a similar state if a cut in the same cutting direction was performed only a few seconds earlier, while a cut a minute ago, or yet earlier still, makes it more likely that the machine is no longer in the same state. Consequently, the process window can also be a function of the time profiles of the available information. This allows temporal aspects to be given consideration during the process window adaptation.

Provision can be made for the process window to be adapted when a machine configuration is changed. In particular, a change in the machine configuration is understood to mean a replacement or cleaning of parts of the beam cutting apparatus, for example a nozzle or a protective glass. This makes it possible to take account of the different effects of new or damaged or contaminated parts on the cutting procedure. Thermal effects, for example a temperature-related modification of the focal position, can also be considered to be a change in the machine configuration. This can counteract recurring effects on account of the cutting apparatus heating up during operation or on account of cooling during pauses in the operation.

The process window can be adapted in a predefined manner when a predefined event (relevant to the process or cutting) occurs. The predefined event might be for example an incomplete cutting action, a collision, in particular between a nozzle and the workpiece or system parts, or a manual change of parameters. What can be achieved by applying suitable corrections to the process window for such events is that a reliable cutting procedure is possible following the corresponding event, even in the case of operation not subject to closed-loop control. By contrast, such events might subsequently cause a miscut in the case of unmodified parameter values.

An admissible region can be predefined for the process window adaptation. As a result, the process window can be prevented from being shifted into regions far beyond the usual parameter values. In particular, an excessively large shift of the process window during one step (in a single adaptation) can be prevented. This can prevent singular events from shifting the process window into a region unsuitable for subsequent cutting during operation not subject to closed-loop control. Additionally, this can also prevent for example the application of an incorrect setup, for instance the setting of an incorrect sheet thickness, the inadvertent loading of a double sheet or the choice of a wrong set of parameters for the correct sheet thickness, etc.

Provision can be made for the cutting procedure to be terminated and/or for a message to be output if the adapted process window and/or the process parameters set during operation subject to closed-loop control reach a boundary of the admissible region. In this respect, a choice of process parameters at the boundary of the admissible region is understood to be and used as an alert with regard to a significant disturbance or malfunction.

The application of operation not subject to closed-loop control can be implemented in predefined situations. This takes account of the fact that certain situations in the cutting procedure might not be resolved satisfactorily under certain circumstances by using the closed-loop control strategy envisaged during operation subject to closed-loop control. By contrast, specifying the process parameters within the (optionally adapted) process window enables a reliable implementation of the cutting procedure during the predefined situation. Once the predefined situation has passed, operation subject to closed-loop control is reverted to as a matter of principle. Conducting operation not subject to closed-loop control within the adapted process window substantially increases the reliability of the cutting procedure being in a stable state, starting from which closed-loop control can be implemented.

Provision can be made for the cutting procedure, especially each individual cutting procedure, to be started in operation not subject to closed-loop control. In this context, the (optionally adapted) process window ensures that the cutting procedure starts successfully. This successful start of the cutting procedure supplies the foundations for a subsequent adaptation of the process parameters during operation subject to closed-loop control.

Provision can be made for a directional change in the cut direction which exceeds a predefined temporal or spatial gradient or a specified curvature to be implemented with operation not subject to closed-loop control. Such quick directional changes may cause the laser cutting apparatus to be temporarily incapable of measurement and hence incapable of closed-loop control, or may cause the closed-loop control on account of its sluggishness to be unable to keep the process within the quality window during or after the curved trajectory. To successfully conduct the cutting procedure, there is thus a switchover to operation not subject to closed-loop control prior to a correspondingly significant directional change; once the directional change has been completed, the cutting procedure is continued with operation subject to closed-loop control.

The process parameters during operation not subject to closed-loop control can be chosen with a safety buffer from the process window boundaries provided the process window comprises a region in the parameter space. This further increases the reliability of the cutting method.

The safety buffer may depend on the type of production mode. Whether the emphasis of the method implementation lies in maximization of reliability or increase in productivity can be set by way of the production mode. For example, the production mode can be a safety mode for an unattended operation or a productivity mode for an increased productivity. A larger safety buffer is specified in the safety mode in comparison with the productivity mode.

In an alternative to that or in addition, the safety buffer can depend on the time elapsed since the last adaptation of the respective process window boundary. This takes account of the fact that machine properties or workpiece properties may change over time. If the last adaptation of the process window boundaries was a long time ago, then the aforementioned changes have potentially not yet been incorporated in the process window definition.

Embodiments of the present invention also include a computer program containing program instructions which, upon execution of the computer program on a control device of a beam cutting apparatus, in particular a laser cutting apparatus, cause the latter to conduct an above-described method according to embodiments of the invention. The computer program allows simple retrofitting of an existing beam cutting apparatus to allow it to conduct the method according to embodiments of the invention.

Embodiments of the present invention also include a computer-readable storage medium, on which a computer program according to embodiments of the invention is stored.

Embodiments of the present invention also include a beam cutting apparatus, in particular a laser cutting apparatus, having a control device configured to conduct an above-described method according to embodiments of the invention. The beam cutting apparatus may comprise a cutting head which is movable relative to a workpiece holder for holding a workpiece. The cutting head may comprise a protective glass for an optical unit. The cutting head may comprise a nozzle, through which a cutting gas can be directed at the workpiece. The beam cutting apparatus may comprise one or more sensors for capturing the at least one quality parameter.

According to embodiments of the invention, the features mentioned above and those still to be further presented can be used in each case individually or together in any desired expedient combinations. The embodiments shown and described should not be understood as an exhaustive enumeration, but rather are of an exemplary character.

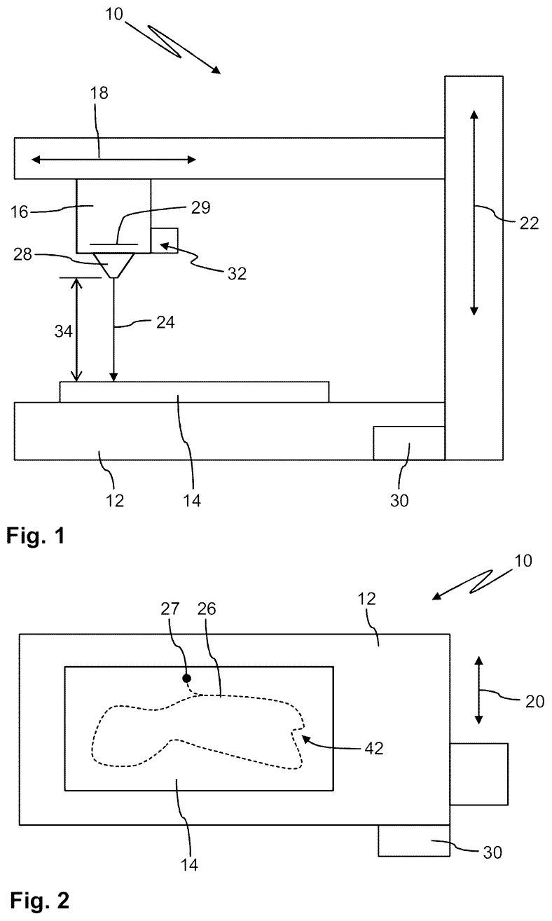

FIG. 1 shows a beam cutting apparatus, which is a laser cutting apparatus 10 in this case. A workpiece 14, in this case a sheet, is held on a workpiece holder 12 of the laser cutting apparatus 10; cf. also FIG. 2. The laser cutting apparatus 10 comprises a cutting head 16. The cutting head 16 is displaceable relative to the workpiece holder 12 along a plurality of translational axes 18, 20, 22. Further, the cutting head 16 can be rotatable about one or more rotational axes in a manner not depicted here in detail.

The cutting head 16 emits a laser beam 24 for the purpose of cutting the workpiece 14. The workpiece 14 is cut along a trajectory 26 by means of the laser beam 24. The separating cut shall start at an incision point 27. By way of example, the trajectory 26 is depicted here as a closed contour. Alternatively, the trajectory could comprise a plurality of separate processing portions and transfer paths therebetween (not depicted in detail). The cutting head 16 can comprise a nozzle 28 for assisting with the processing of the workpiece 14 with the laser beam 24. A cutting gas can be blown on the workpiece 14 through the nozzle 28. The cutting head 16 may also comprise a protective glass 29 for an optical unit not depicted in detail.

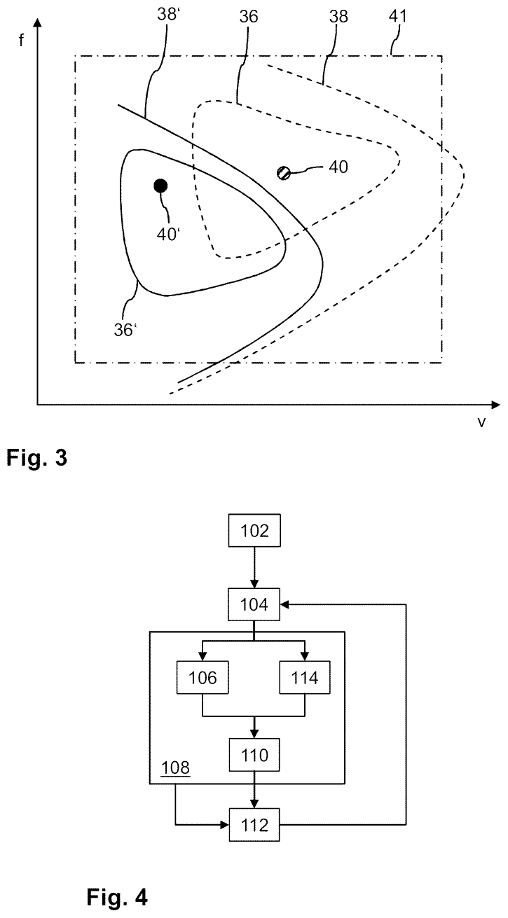

The laser cutting apparatus 10 comprises a control device 30. The control device 30 causes the implementation of the cutting procedure under the specification and adaptation of various process parameters. For example, two of the process parameters might be a feed rate v and a focal position f (i.e. the position of the focus of the laser beam 24 relative to the workpiece 14); cf. FIG. 3. Further process parameters can be a laser power, a focal diameter, a gas pressure of the cutting gas prior to emerging from the nozzle 28, a mass flow rate of the cutting gas through the nozzle 28 and/or a distance 34 between nozzle and workpiece 14. Overall, the process parameters span a multidimensional parameter space, a two-dimensional projection of which is shown in FIG. 3 by way of example.

Further, the laser cutting apparatus 10 comprises a sensor system 32. The sensor system 32 may comprise a plurality of sensors (not depicted in detail) for ascertaining quality parameters for the cutting procedure. For example, the sensors can be arranged in or on the cutting head 16. Some of the sensors might also be arranged at a different location on the laser cutting apparatus 10 or in the surroundings thereof. The sensor system 32 may comprise, inter alia, an optical sensor, in particular a camera. The sensor system 32 can preferably allow ascertainment of a cutting edge quality, a width of the kerf, a cutting front angle and/or the presence of a separating cut or a miscut.

For the purpose of conducting the cutting method, a process window 36 (see FIG. 3) is specified in the parameter space of the process parameters; cf. step 102 in FIG. 4. The process window 36 is initially defined for an unperturbed state corresponding to a nominal state of the laser cutting apparatus 10 and workpiece 14. In this context, it is possible to take account of machine properties like the type of cutting head 16, a wavelength of the laser beam 24, a type of cutting gas and/or a type of nozzle 28. Moreover, workpiece properties like the material of the workpiece 14, the thickness of the workpiece 14 and/or nature of the surface of the workpiece 14 can be taken into account.

FIG. 3 also plots a quality boundary 38, at which the cutting procedure transitions from a successful to a faulty regime. In this case, a separating cut of sufficient quality is implemented to the left of the quality boundary 38, and a miscut is implemented to the right of the quality boundary 38. In the multidimensional parameter space, the process window 36 lies in the region enabling a successful implementation of the separating cut with sufficient quality. In particular, the process window 36 can be specified to have a certain distance from the quality boundary 38. A high-quality separating cut can be obtained as a result.

An operating point 40 is chosen within the process window 36 in a step 104. The operating point 40 can be specified with a safety buffer from the boundaries or edges of the process window 36. The safety buffer can be chosen on the basis of the productivity or reliability requirements of a production mode.

The cutting procedure starts at the incision point 27 with the process parameters chosen in accordance with the operating point 40; cf. step 106. Thus, the cut is started with an operation not subject to closed-loop control, with defined process parameters and without feedback of quality parameters. If possible, the quality parameters are captured by the sensor system 32 even during operation not subject to closed-loop control; cf. overarching step 108 in FIG. 4.

After a short piece of the trajectory 26 has been cut using the specified process parameters there is a switchover to operation subject to closed-loop control. Going forward, the cutting procedure is implemented under closed-loop control using feedback of the quality parameters captured by the sensor system 32 and with modifications to the process parameters in accordance with a specified closed-loop control strategy; cf. step 110. In this case, the process parameters may depart from the originally specified process window 36.

A disturbance might occur over the course of the cutting procedure. For example, a spatter may contaminate the protective glass 29. The control device 30 identifies this on the basis of a deterioration in the quality parameters captured by the sensor system 32. The disturbance might lead to a modified position of the quality boundary 38′ in the parameter space.

Thus, the control device reacts with an adaptation of the process parameters during operation subject to closed-loop control. For example, the feed rate v might be reduced, the focal position f might be placed closer to the workpiece 14 and the laser power might be increased.

The process window is adapted in a step 112 using the values of the process parameters modified thus, with the result that it receives the size, shape and position denoted by 36′ in FIG. 3. In this context, the process window 36′ can be adapted continually or repeatedly. In particular, the current processing position in the work space and/or the cut direction can also be taken into account, with the result that different process windows are obtained in spatially or directionally dependent fashion and/or temporally dependent fashion (not depicted in detail). Adapting the process window 36′ can be restricted to an admissible region 41.

Going forward, the trajectory 26 might have sharp directional changes 42. There might be the risk of an incomplete cutting action for the chosen closed-loop control strategy and such sharp directional changes, for example if significant directional dependencies are present and the closed-loop control is too sluggish or the laser cutting apparatus is not capable of measurement in such sharp curves. Therefore, a new operating point 40′ is chosen in the adapted process window 36′ in a renewed implementation of step 104. The cutting procedure in the region of the directional changes 42 is then implemented with operation not subject to closed-loop control; cf. step 114, wherein the process parameters are chosen at the adapted operating point 40′. Should the dynamics of the laser cutting apparatus 10 in the region of the directional changes 42 not allow the feed rate to be chosen in accordance with the operating point 40′, then the cutting procedure can be conducted with a lower feed rate there. In that case, further process parameters may be additionally adapted (for example the laser power) in order to obtain a good quality even in the case of a relatively small feed. The feed rate of the operating point 40′ then serves as a limit value which is not exceeded in the region of the directional changes 42. To the extent allowed by the dynamics, the feed rate during operation not subject to closed-loop control is set to the value corresponding to the operating point 40′.

Following the traversal of the sharp directional changes 42, there is a switchover back to the operation subject to closed-loop control according to step 110. Prior to the switchover to operation subject to closed-loop control, e.g. the feed rate can within the scope of the directional dependence of the process window 36′ be brought to the value last applied in this direction during the preceding operation subject to closed-loop control. Alternatively, it is also possible to choose a lower value in order to achieve higher safety, especially if the last cut in this new direction took place a relatively long time ago.

The above-described procedure can be repeated during the further course of the cutting procedure on the workpiece 14. The same procedure as described above is also implemented for a further cutting procedure with a new incision in the workpiece 14 or in a further workpiece, with the operating point in each case being selected within the current process window 36′ in step 104.

The process window 36′ is adapted if the contaminated protective glass 29 has been cleaned or replaced. In particular, its boundaries may once again correspond to those of the process window 36 if no other disturbances have occurred in the meantime.

Provision can also be made for a predefined adaptation of the process window to be implemented for specific events, for example in the event of a collision of the nozzle 28 with the workpiece 14 or in the event of an incomplete cutting action. For example, in the event of an incomplete cutting action, provision can be made for the feed rate in the adapted process window to be reduced by a certain absolute value or factor vis-à-vis the feed rate at which the incomplete cutting action occurred. Such an incomplete cutting action may occur both during operation subject to closed-loop control and operation not subject to closed-loop control, for example on account of slag adherence to the nozzle 28, impeding the through-flow of cutting gas. The process window is modified accordingly in order to allow further cutting and prevent a renewed incomplete cutting action before the cause is rectified.

In summary, the beam cutting method comprises an operating mode not subject to closed-loop control (steps 104, 106, 114) and an operating mode subject to closed-loop control (step 110). Quality parameters for the cutting procedure are captured in both operating modes. During operation not subject to closed-loop control, the process parameters are set to an operating point within an adaptive process window. During operation subject to closed-loop control, the process parameters are modified on the basis of a specified closed-loop control strategy while quality parameters are taken into account, wherein they may exceed the boundaries of the previous process window. The changes in the process parameters during operation subject to closed-loop control are used to adapt the boundaries of the process window for operation not subject to closed-loop control. The next phase of the operation not subject to closed-loop control is implemented using an operating point within the adapted process window The process parameters in different phases of operation not subject to closed-loop control therefore typically differ from one another.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B. or the entire list of elements A. B and C.

### LIST OF REFERENCE SIGNS

Laser cutting apparatus 10
Workpiece holder 12
Workpiece 14
Cutting head 16
Translational axes 18, 20, 22
Laser beam 24
Trajectory 26
Incision point 27
Nozzle 28
Protective glass 29
Control device 30
Sensor system 32
Distance 34
Process window 36, 36′
Quality boundary 38, 38′
Operating point 40, 40′
Admissible region 41
Directional change 42
Feed rate v
Focal position f
102: Defining the process window
104: Choosing the operating point in the process window
106: Starting the cutting procedure with operation not subject to closed-loop control
108: Capturing the quality parameters
110: Cutting with closed-loop control
112: Adapting the process window
114: Cutting without closed-loop control

1. A beam cutting method, comprising:
conducting at least one cutting procedure while capturing at least one quality parameter, wherein the at least one cutting procedure is intermittently implemented with an operation not subject to a closed-loop control and intermittently implemented with an operation subject to the closed-loop control,
defining a process window in a parameter space of at least one process parameter,
choosing the at least one process parameter within the process window during the operation not subject to the closed-loop control, wherein the at least one process parameter is allowed to be outside of the process window during the operation subject to the closed-loop control, and
adapting the process window based on changes in the at least one process parameter during the operation subject to the closed-loop control and/or changes in the at least one quality parameter.

2. The beam cutting method as claimed in claim 1, wherein the beam cutting method is a laser cutting method.

3. The beam cutting method as claimed in claim 1, further comprising capturing the changes in the process parameters during the operation subject to the closed-loop control and/or the changes in the at least one quality parameter in spatially dependent and/or directionally dependent and/or temporally dependent fashion, and wherein the process window is adapted in spatially dependent and/or directionally dependent and/or temporally dependent fashion.

4. The beam cutting method as claimed in claim 1, wherein the process window is adapted when a machine configuration is changed.

5. The beam cutting method as claimed in claim 1, wherein the process window is adapted in a predefined manner when a predefined event occurs.

6. The beam cutting method as claimed in claim 1, wherein an admissible region is predefined for the adapting of the process window.

7. The beam cutting method as claimed in claim 1, wherein the at least one cutting procedure is started in the operation not subject to the closed-loop control.

8. The beam cutting method as claimed in claim 1, further comprising implementing a directional change in a cut direction which exceeds a predefined temporal or spatial gradient with the operation not subject to the closed-loop control.

9. The beam cutting method as claimed in claim 1, wherein the at least one process parameter during the operation not subject to the closed-loop control is chosen with a safety buffer from the process window boundaries.

10. The beam cutting method as claimed in claim 9, wherein the safety buffer depends on a type of production mode and/or time elapsed since a last adaptation of the process window.

11. The beam cutting method as claimed in claim 1, wherein the at least one quality parameter comprises one of a presence of a separating cut, width and/or profile of a cut gap, or inclination and/or shape of a cutting front.

12. The beam cutting method as claimed in claim 1, wherein the at least one process parameter comprises one of a feed rate, a laser power, a focal position, a focal diameter, a distance of a nozzle from a workpiece, or a gas pressure and/or gas composition of a cutting gas.

13. The beam cutting method as claimed in claim 1, wherein the process window is defined based on machine properties and/or workpiece properties.

14. A non-transitory computer-readable medium having program instructions stored thereon, upon execution of the program instructions on a control device of a beam cutting apparatus, cause the beam cutting apparatus to conduct a beam cutting method as claimed in claim 1.

15. A beam cutting apparatus having a control device configured to conduct a beam cutting method as claimed in claim 1.
